(19) United States
(12) Patent Application Publication
(10) Pub. No.: US 2016/0225006 A1
(43) Pub. Date: Aug. 4, 2016

(54) UTILIZATION OF COUPONS IN RESIDENTIAL DEMAND RESPONSE

(71) Applicant: FUJITSU LIMITED, Kawasaki-shi (JP)

(72) Inventor: Wei-Peng CHEN, Fremont, CA (US)

(21) Appl. No.: 14/610,929

(22) Filed: Jan. 30, 2015

(51) Int. Cl. G06Q 30/02; G06F 17/30

(52) U.S. Cl. CPC G06Q 30/0224; G06Q 30/0235; G06F 17/30867; G06Q 30/0236

(57) ABSTRACT

A method includes determining user interests associated with a user. The method includes receiving multiple offers from multiple merchants that each include a purchase incentive to purchase a good or service and a category of interest associated with the good or service. The method includes identifying a match between the user and an offer from the multiple offers, including matching the user interests associated with the user to the category of interest associated with the good or service. The method includes determining a time period associated with a demand response event. The method includes generating a coupon for the user that includes the offer and a performance bonus that provides a performance incentive to redeem the coupon at a specified physical location during the time period associated with the demand response event. The method includes providing the coupon to the user for redemption at the specified physical location.

### FIELD

The embodiments discussed herein are related to utilization of coupons in residential demand response.

### BACKGROUND

Utilities incentivize curtailment of resource usage during certain high load periods to increase the ability of the utilities to meet a larger demand or to minimize production costs. For example, in summer months, peak energy usage may occur on hot days in the late afternoon. A utility may offer an incentive to a customer to reduce energy usage in the customer's home during the late afternoon. In response, the customer may avoid doing the dishes, turn down the air-conditioning in the home, or otherwise reduce energy usage. Since a single residence may not consume enough energy to make a large difference in energy consumption, the utility may offer incentives to many customers and an aggregation of resource curtailment at the homes associated with the customers may be enough to reduce consumption for a demand response event. In this manner, the utility may increase its ability to meet energy demands during the peak energy usage and/or avoid producing or purchasing additional energy to meet the energy demands.

The curtailment in resource usage during peak or high load periods may be referred to generally as demand response (DR). The resource usage curtailment during a specified time period may be referred to as a DR event. DR events generally occur when a utility expects a high demand and asks customers to reduce or curtail resource usage. Some DR systems include DR aggregators. The DR aggregators may mediate communication between utilities and customers. The DR aggregators generally have an agreement with the utilities to coordinate with the customers and implement DR events.

The subject matter claimed herein is not limited to embodiments that solve any disadvantages or that operate only in environments such as those described above. Rather, this background is only provided to illustrate one example technology area where some embodiments described herein may be practiced.

### SUMMARY

According to an aspect of an embodiment, a method to match a coupon with a user to be redeemed during a demand response event may include determining one or more user interests associated with a user. The method may also include receiving multiple offers from multiple merchants that each include a purchase incentive to purchase a good or service and a category of interest associated with the good or service. The method may also include identifying a match between the user and an offer from the multiple offers, including matching the one or more user interests associated with the user to the category of interest associated with the good or service. The method may also include determining a time period associated with a demand response event. The method may also include generating a coupon for the user that includes the offer and a performance bonus that provides a performance incentive to redeem the coupon at a specified physical location during the time period associated with the demand response. The method may also include providing the coupon to the user for redemption at the specified physical location, redemption of the coupon at the specified physical location by the user causing a reduction in resource consumption at a residential location associated with the user.

The object and advantages of the embodiments will be realized and achieved at least by the elements, features, and combinations particularly pointed out in the claims.

It is to be understood that both the foregoing general description and the following detailed description are exemplary and explanatory and are not restrictive of the invention, as claimed.

### BRIEF DESCRIPTION OF THE DRAWINGS

Example embodiments will be described and explained with additional specificity and detail through the use of the accompanying drawings in which:

FIG. 1 is a block diagram of an example demand response system configured to match a coupon with a user to be redeemed during a demand response event;

FIG. 2 illustrates an example device to match a coupon with a user to be redeemed during a demand response event;

FIG. 3 illustrates an example graphical user interface that includes a coupon and different types of incentives;

FIG. 4 illustrates a flowchart of an example method to match a coupon with a user to be redeemed during a demand response event; and

FIG. 5 illustrates a flowchart of an example method to bid for a resource based on a demand response event.

### DESCRIPTION OF EMBODIMENTS

Traditional residential demand response (DR) programs provide incentives to users to curtail resource consumption in their residences. These programs may have low compliance because the users may find the incentives to be insufficient and not worth the inconvenience of curtailing resource consumption. In addition, it may be difficult to predict which users will comply with the program and when they will comply with the program. As a result, it may be difficult to predict how much resource consumption may be curtailed. If the resource consumption is unpredictable, a utility and/or DR aggregator may not want to take action based on predictions because of a penalty associated with being wrong.

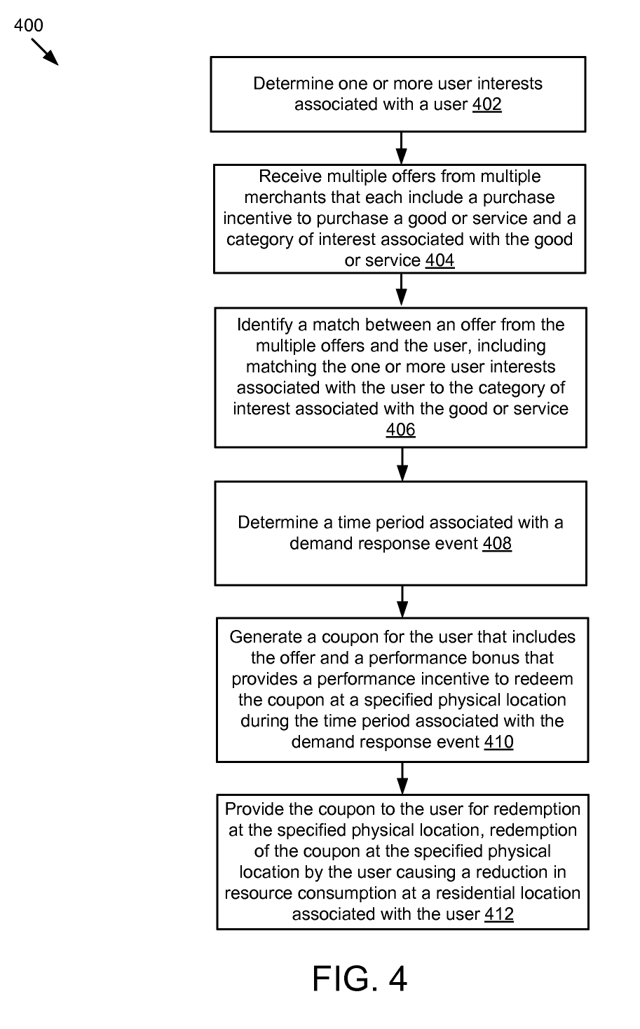

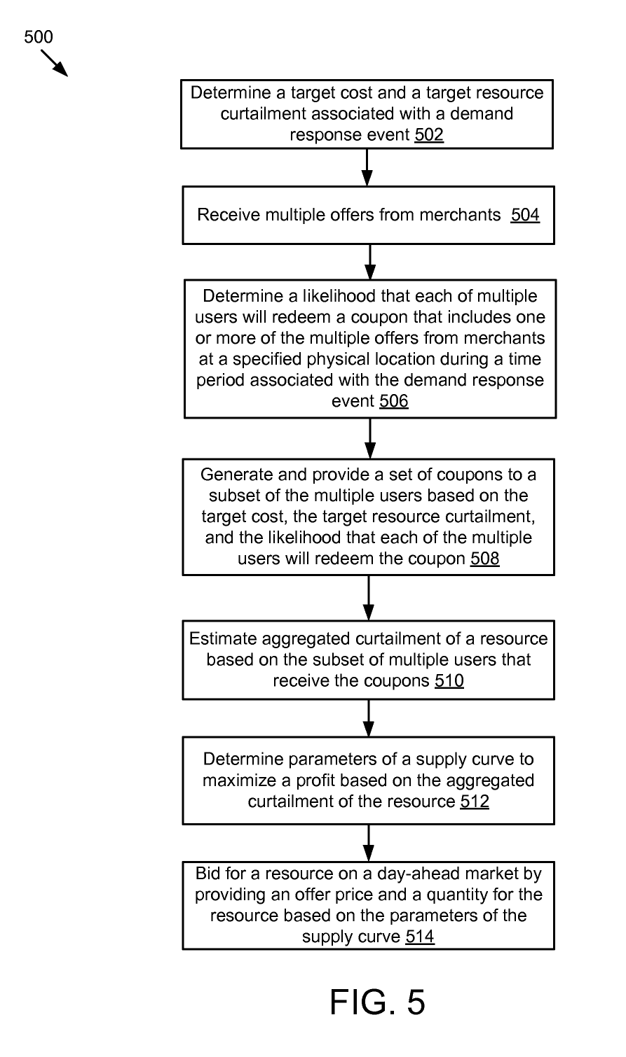

The deficiencies of these and other systems may be overcome by a DR system where both a utility and a merchant provide incentives to the user that cause the user to reduce resource consumption. The DR system described herein may include a computing device. For example, the DR system may include a personal computer, laptop, tablet computer, mobile telephone, server or any processor-based computing device. The DR system may include a memory and a processor device. The processor device may be programmed to perform or control performance of one or more operations described herein, such as one or more operations or steps of methods 400 and 500 described below with reference to FIG. 4 and FIG. 5, respectively. One or more example embodiments of the DR system are described below.

The DR system may include a DR application that determines user interests associated with a user. For example, the DR application may determine that the user is interested in movies. The DR application may receive offers from merchants that each include a purchase incentive to purchase a good or service and a category of interest associated with the good or service. For example, an offer may include 20% off of items at a clothing store, $5 off of movie tickets, etc. The DR application may identify a match between one of the offers and the user by matching the user interests to the categories of interest associated with the goods or services. For example, the DR application may identify a match between the offer for $5 off of movie tickets with the user because the user is interested in movies.

The DR application may determine a time period associated with a demand response event. The time period may be dynamic and include short time periods, such as a week, a day, or minutes from a current time. The DR application may generate a coupon for the user that includes the offer and a performance bonus that provides a performance incentive to redeem the coupon at a specified physical location during the time period associated with the demand response event. In this example, the specified physical location may be a cinema associated with a merchant that provided the matching offer. The coupon may include, for example, the offer of $5 off of movie tickets as provided by the merchant and $5 (e.g., towards concessions) provided by a utility for redeeming the coupon during the time period associated with the demand response event. As a result, the DR application advantageously uses multiple revenue sources to incentivize the user to reduce residential resource consumption.

The coupon may also include a sign-up bonus that provides a sign-up incentive to agree to redeem the coupon during the time period associated with the demand response event. If the user agrees to redeem the coupon, the DR application may notify the merchant (e.g., through a merchant server that issued the offer). This may advantageously result in the merchant receiving advance notice of the user. In addition, the time period associated with the demand response event may overlap with a slow period in the merchant's store, which may result in increased ticket and/or concession sales for the merchant during the slow period.

The DR application may generate coupons for multiple users. The DR application may generate coupons for a subset of users based on a likelihood that the users will redeem the coupons at specified physical locations during the time period associated with the demand response event. The DR application may estimate an aggregated curtailment of a resource based on the subset of users that receive the coupons. For example, the DR application may estimate the aggregated curtailment of the resource based on a sum of the likelihood that each of the users in the subset of users will redeem the coupon multiplied by a load reduction for each of the users in the subset of users. The DR application may use the aggregated curtailment of the resource to bid for the resource on a day-ahead market by providing an offer price and a quantity for the resource that is based on the aggregated curtailment of the resource. In some embodiments, the DR application may use the aggregated curtailment of the resource to determine a profit and the DR application may use the profit to determine the offer price and the quantity for the resource. The DR application may update the target cost and the target resource curtailment. For example, the DR application may determine that an additional amount of the resource is needed to meet demand. The DR application may issue an additional subset of coupons and bid for the additional resource on an hour-ahead market.

Some embodiments will be explained with reference to the accompanying drawings. With respect to the use of substantially any plural and/or singular terms herein, those having skill in the art may translate from the plural to the singular and/or from the singular to the plural as is appropriate to the context and/or application. The various singular/plural permutations may be expressly set forth herein for sake of clarity.

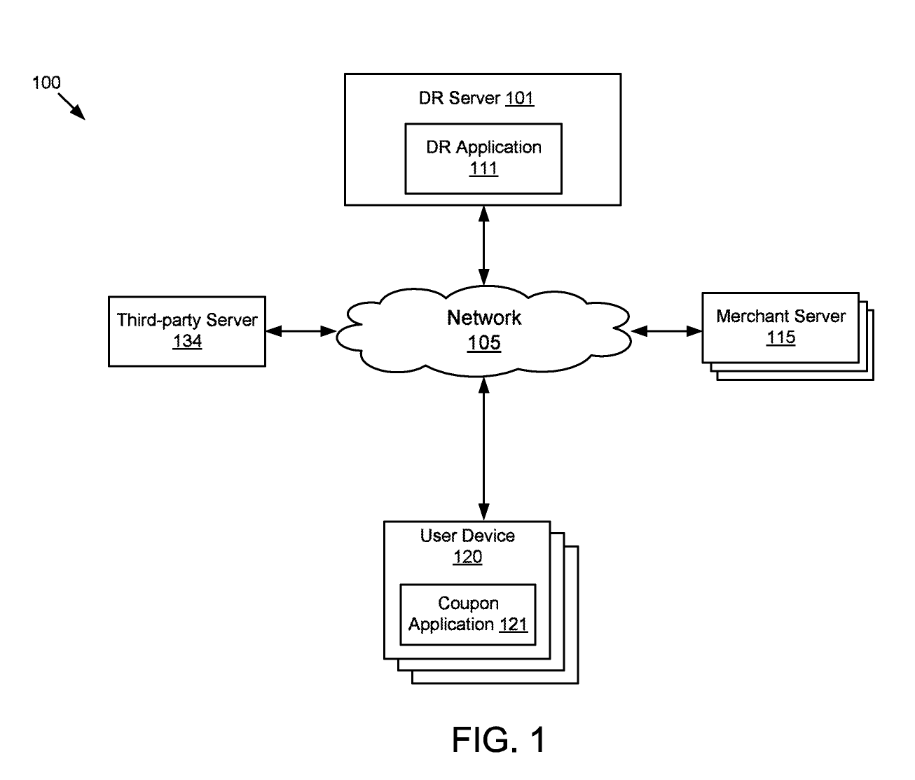

FIG. 1 is a block diagram of an example DR system 100 configured to match a coupon with a user to be redeemed during a demand response event, arranged in accordance with at least some embodiments described herein. The DR system 100 may include a DR server 101, a merchant server 115, user devices 120, and a third-party server 134 that may communicate with each other via a network 105. One or more example implementations of the DR system 100 are described below.

The network 105 may include one or more wide area networks (WANs) and/or local area networks (LANs) that may enable communication among the DR server 101, the merchant servers 115, the user devices 120, and the third-party servers 134. In some embodiments, the network 105 includes the Internet, including a global internetwork formed by logical and physical connections between multiple WANs and/or LANs. Alternately or additionally, the network 105 may include one or more cellular radio frequency (RF) networks, GPS networks, and/or one or more wired and/or wireless networks such as, but not limited to, 802.xx networks, Bluetooth access points, wireless access points, or internet protocol (IP)-based networks. The network 105 may also include servers that enable one type of network to interface with another type of network.

The DR server 101 may be associated with utility and/or a DR aggregator. The utility may include any load serving entity (LSE) involved in production, transmission, and/or distribution of a resource. The utility may be publicly owned or privately owned. Some examples of the utility may include, but are not limited to, a power company, an energy cooperative, and a water company. The utility may be configured to identify a DR event and set one or more terms for the DR event such as types of incentives, a time period associated with the DR event, a target cost, and a target resource.

The DR aggregator may act as an intermediary between the utility, merchants, and users associated with the user devices 120 to coordinate implementation of DR events. In particular, the DR aggregator may coordinate DR events such that an aggregated curtailment of resources at residences of the users is sufficient to meet an overall energy usage curtailment of a DR event. In some embodiments, an incentive offered by the utility may be received by the DR aggregator. The DR aggregator may in turn offer some portion of the incentive to the users in exchange for participation in a DR event. The DR aggregator may coordinate implementation of DR events with the users through the user devices 120. In some embodiments, the aggregator may be part of a utility.

The DR server 101 may include applications and/or hardware (e.g., rack-mounted server computers, blade server computers, and/or other computer hardware). The DR server 101 may include a memory and a processor device. The processor device may be programmed to perform or control performance of one or more operations described herein, such as one or more operations or steps of the methods 400 and 500 described below with reference to FIG. 4 and FIG. 5, respectively.

The DR server 101 may include a DR application 111 that is configured to match a coupon with a user to be redeemed during a demand response event. For example, the DR application 111 may receive user interests associated with a user from a user device 120. The DR application 111 may receive offers associated with merchants from the merchant servers 115. The offers may include a purchase incentive to purchase a good or service and a category or categories of interest associated with the good or service. The DR application 111 may identify a match between the user and one of the offers based on one of the user interests matching one of the categories of interest associated with the good or service.

The DR application 111 may also be configured to bid for a resource on a market that is managed by the third-party server 134. The DR application 111 may bid multiple times as the DR application 111 receives new information. As a time to the DR event gets closer, the DR application 111 may switch from bidding on a day-ahead market to bidding on an hour-ahead market.

The merchant servers 115 may include applications and/or hardware (e.g., rack-mounted server computers, blade server computers, and/or other computer hardware) that are configured to provide offers to the DR server 101 to encourage users to visit their physical store locations. The merchant servers 115 may each include a memory and a processor device. The processor device may be programmed to perform or control performance of one or more operations described herein, for example, the merchant servers 115 may be programmed to provide offer information to the DR server 101 including incentives for users to purchase goods or services, categories of interest associated with the goods or services, sign-up bonuses, and additional bidding information that the DR server 101 uses to determine how to match a user to an offer.

The third-party server 134 may be managed by a third party. The third party may include an entity that controls or manages exchange of a resource in the DR system 100. The third party 134 may ensure that the resource is properly allocated among residences, enable a price of the resource to be set for the residences and/or a distribution channel (e.g., one or more substations, distribution wiring, piping, pumps, tanks, or any other component on which or through which a resource may be transferred between a utility and a residence) and provide a market for the exchange of the resource. In some embodiments in which a utility supplies electricity to the residences, the third-party server 134 may include an independent system operator (ISO) or a regional transmission organization (RTO), for instance.

The third-party server 134 may include applications and/or hardware (e.g., rack-mounted server computers, blade server computers, and/or other computer hardware) that are configured to receive, calculate, and/or publish information related to supply and demand of a resource on a distribution channel. The information may be received, calculated, and/or published continuously, periodically, randomly, pseudo-randomly, or on-demand. The third-party server 134 may then calculate economic data and publish the economic data related to the distribution channel.

In some embodiments, the third-party server 134 may be configured to host a website that is accessible via the network 105. The third-party server 134 may provide access to the website by the DR application 111 via the DR server 101. The DR application 111 may accordingly access and/or interface with the website via the DR server 101. The website may provide a user interface to the DR application 111 accessing the website. In particular, the economic data may be accessible via the website. Additionally or alternatively, the third-party server 134 may communicate the economic data to the DR server 101 continuously, periodically, randomly, pseudo-randomly, or on-demand.

The user devices 120 may include personal computing devices that each include a memory and a processor, for example, a desktop computer, a laptop computer, a tablet computer, a mobile telephone, a personal digital assistant (PDA), a mobile e-mail device, a portable game player, a portable music player, a wearable device, or other electronic device capable of accessing the network 105. In some embodiments, the user devices 120 may each include a processor-based computing device.

The user devices 120 may include a coupon application 121. In some embodiments, the coupon application 121 may be implemented using hardware including a field-programmable gate array (FPGA) or an application-specific integrated circuit (ASIC). In some other embodiments, the coupon application 121 may be implemented using a combination of hardware and software.

The coupon application 121 may be configured to receive graphical data from the DR application 111 and display the graphical data on a display associated with the user device 120. For example, the DR application 111 may transmit graphical data for displaying a user interface that includes fields for a user to provide registration information. The registration information may include identifying information for the user and user interests. For example, a user may select a username and password, and provide a list of interests. Examples of interests include relatively broad interests such as sports, fashion, politics, art, music, movies, etc.; relatively narrow interests such as particular types or subcategories of the foregoing including soccer (or football), American football, swimming, or other sports, men's clothing, women's clothing, formal wear, or other types or subcategories of fashion, comedies, action movies, dramas, independent films, or other movie genres, etc.; or even narrower interests such as particular sports teams or levels (e.g., college versus professional), particular fashion designers, particular movie subgenres, studios, directors, and/or actors/actresses, etc. The coupon application 121 may also be configured to receive graphical data from the DR application 111 for generating a user interface that includes a coupon. The coupon may include machine readable code, such as a barcode or a QR code, so that a user may present the coupon to a merchant for redemption. Alternatively, the user may print a hardcopy of the coupon and present the hardcopy (including the machine readable code) to the merchant for redemption. The merchant may scan the machine readable code to determine a value of an incentive included in the coupon.

In some embodiments, the coupon application 121 may act in part as a thin-client application that may be stored in part on the user device 120 and in part on the DR server 101 as part of the DR application 111. In some embodiments, a user accesses the DR application 111 instead of the coupon application 121, for example, by accessing the DR application 111 via a browser.

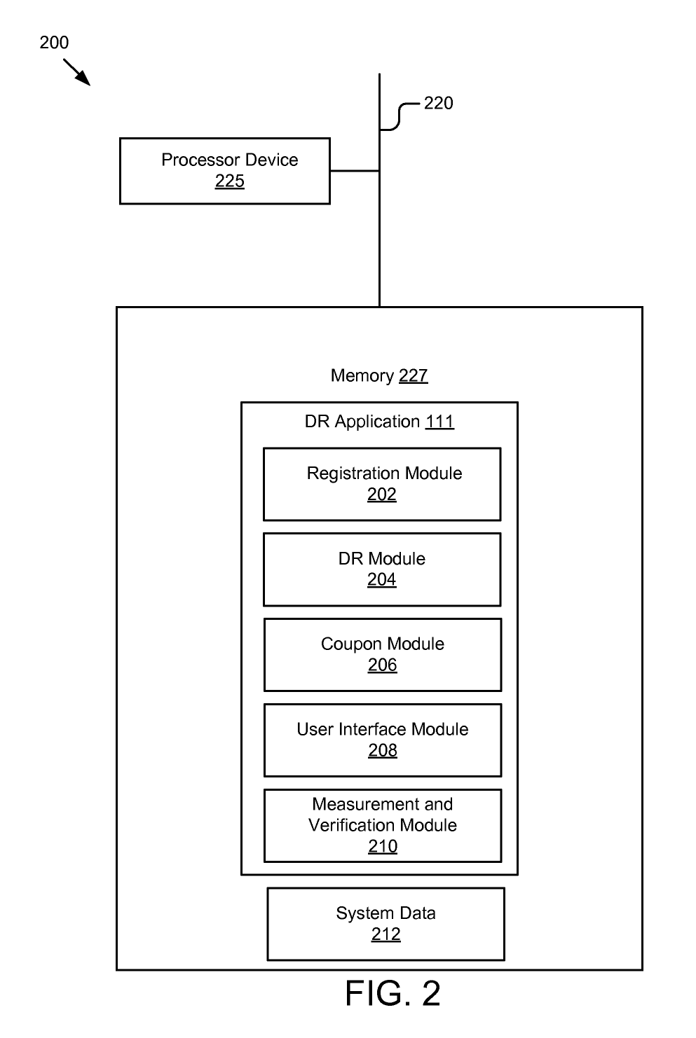

FIG. 2 illustrates an example device 200 to match a coupon with a user to be redeemed during a demand response event, arranged in accordance with at least some embodiments described herein. The device 200 of FIG. 2 may be an example of hardware used by the DR system 100 described above with reference to FIG. 1. The device 200 may include a special purpose processor-based computing device programmed to perform one or more blocks of the methods 400 and 500 described below with reference to FIG. 4 and FIG. 5, respectively.

The device 200 may include a processor device 225 and a memory 227. The processor device 225 may include an arithmetic logic unit, a microprocessor, a general-purpose controller, or some other processor or processor array to perform or control performance of operations as described herein. The processor device 225 processes data signals and may include various computing architectures including a complex instruction set computer (CISC) architecture, a reduced instruction set computer (RISC) architecture, or an architecture implementing a combination of instruction sets. Although FIG. 2 illustrates a single processor device 225, the device 200 may include multiple processor devices 225. Other processors, operating systems, and physical configurations may be possible.

The memory 227 stores instructions or data that may be executed or operated on by the processor device 225. The instructions or data may include programming code that may be executed by the processor device 225 to perform or control performance of the operations described herein. The memory 227 may include a Dynamic Random Access Memory (DRAM) device, a Static Random Access Memory (SRAM) device, flash memory, or some other memory device. In some embodiments, the memory 227 also includes a non-volatile memory or similar permanent storage and media including a hard disk drive, a floppy disk drive, a Compact Disc-ROM (CD-ROM) device, a DVD-ROM device, a DVD-RAM device, a DVD-RW device, a flash memory device, or some other mass storage for storing information on a more permanent basis.

In the depicted embodiment, the memory 227 may store one or more of the DR application 111 of FIG. 1 and system data 212. In some embodiments, the DR application 111 may be implemented using hardware including a field-programmable gate array (FPGA) or an application-specific integrated circuit (ASIC). In some other embodiments, the DR application 111 may be implemented using a combination of hardware and software.

The DR application 111 may include a registration module 202, a DR module 204, a coupon module 206, a user interface module 208, and a measurement and verification module 210. While the modules 202, 204, 206, 208, and 210 are illustrated as being stored on one device 200, the modules 202, 204, 206, 208, and 210 may be stored on different devices, for example, in a distributed data system.

The system data 212 may include data used by the device 200 to provide its functionality. For example, the system data 212 may include one or more of user information, merchant information, and DR information. The user information may include usernames; passwords; user interests; addresses associated with users; shopping preferences; interests in types of coupons; types of residential appliances; historical resource consumption associated with users; and historical behavior, such as information about when users redeemed coupons, what percentage of coupons were redeemed, and a value of the incentives. The merchant information may include offers provided by the merchants, which offers are selected during bidding, and which offers are part of a coupon that was redeemed. The DR information may include time periods associated with DR events and bidding information, such as a supply curve, a profit model, forecasts for day-ahead markets, and forecasts for real-time market.

The various modules 202, 204, 206, 208, and 210 of the DR application 111 will now be described in more detail.

The registration module 202 may generally be configured to register a user. For example, the registration module 202 may instruct the user interface module 208 to generate a user interface with fields for the user to provide a username, a password, user interests, addresses associated with users, shopping preferences, interests in types of coupons, types of residential appliances, historical resource consumption associated with users, and historical behavior. The user interests may include activities that the user enjoys performing (e.g., soccer), topics that the user is interested in (e.g., contemporary art), and subjects that the user likes (e.g., dark chocolate). The user interests may be general (e.g., tea) or specific (e.g., gunpowder green tea from the Chinese province of Zhejiang).

The types of residential appliances may include, for example, appliances that are divided into products and types according to the midcontinent ISO (MISO) as discussed in greater detail below with reference to the DR module 204. Historical behavior may include information about when users redeemed coupons, what percentage of coupons were redeemed, and a value of the incentives. The registration module 202 may receive the username, password, and user interests from the user and generate a user profile for the user that includes the information.

In some embodiments, the registration module 202 may receive information from other sources to determine user interests. For example, the registration module 202 may instruct the user interface module 208 to generate an option for a user to input login information for a social network. The registration module 202 may determine user interests from a user profile associated with the social network, activities on the social network, etc.

The registration module 202 may register the user for a DR program. The DR program may include providing incentives to the user in exchange for the user curtailing resource consumption at the user's residence. For example, where the resource is water, the user may agree to reduce water consumption during a DR event. In practice, this may mean that during the DR event the user shuts off an automatic sprinkler system, does not wash dishes or run a dishwasher, does not take a shower, etc. It may be easier for the user to curtail resource consumption during the DR event responsive to the user receiving a coupon because the user may be less likely to consume resources when the user is at a store to redeem the coupon instead of staying at the user's residence. As a result, in some embodiments the user does not consume resources during the DR event because it may occur naturally as a result of the user being at the store.

As part of the DR program, the registration module 202 may generate a loyalty program for the user. The loyalty program may include reward points that the user may redeem at stores associated with merchants that participate in the loyalty program. For example, 100 reward points may be exchanged for $50, or some other number of reward points may be exchanged for some other dollar value, in-store credit, or other value.

The DR module 204 may generally be configured to determine a DR event, identify users to be matched with coupons, estimate an aggregated curtailment of a resource based on the users that receive the coupons, determine a profit, and bid for the resource. These steps may be repeated iteratively after receiving additional data from the coupon module 206 and/or the user interface module 208.

The DR module 204 may be configured to determine a DR event that exploits a demand imbalance that exists on a distribution channel. For example, the DR event may be configured to curtail the resource to avoid a purchase of the resource at the real-time price (e.g., locational marginal pricing (LMP)). Alternatively, the DR module 204 may be configured to curtail a resource to create an excess that may be sold at the real-time price.

The information associated with the DR event may include a time period associated with a demand response event, a target resource curtailment and a target cost. The DR module 204 may be configured to determine a time period associated with a demand response event. The time period associated with the DR event may be continuous or include intervals. The DR module 204 may determine the time period associated with the DR event one week before the DR event, one day before, minutes before, etc. In some embodiments, the DR module 204 performs an iterative process of receiving offers from merchants, identifying users to receive coupons, estimating an aggregated curtailment of a resource based on the users that will receive coupons, bidding for the resource, receiving updated information, and repeating the process until the time period associated with the DR event occurs.

For example, one week before the time period associated with the DR event, the DR module 204 may receive offers from merchants. Three days before the time period associated with the DR event, the coupon module 206 may issue coupons to users. At 12 p.m. the day before the time period associated with the DR event, the DR module 204 may bid for the resource on a day-ahead market. The DR module 204 and the coupon module 206 may repeat the previous steps, and the DR module 204 may continue to bid on the resource with updated information until 4 p.m. the day before the time period associated with the DR event. One hour before the time period associated with the DR event the DR module 204 may bid for the resource on a real-time market. The DR module 204 may continue to bid on the resource with updated information on the real-time market until the DR event occurs. Examples of day-ahead markets and real-time markets may include PJM, ISO New England (ISO-NE), and New York Independent System Operator (NYISO).

The DR module 204 may be configured to determine a target resource curtailment. The target resource curtailment may include an estimated amount of curtailment of a resource to occur during the DR event. The DR module 204 may determine the target resource curtailment based on resource economic data from the third party server 134. For example, the DR module 204 may read the economic data from a website or may receive a communication from the third party server 134. In the depicted embodiment, the DR module 204 may read a day-ahead demand, a day-ahead LMP, and a real-time LMP. Alternatively, in some embodiments, the DR module 204 may receive or access the economic data from another entity that receives and/or calculates the economic data.

Additionally, the DR module 204 may estimate a real-time resource demand. For example, the DR module 204 may receive meter readings from the residences and/or from a resource feeder entity, such as a meter reading at a substation. The DR module 204 may then aggregate the meter readings to estimate the real-time resource demand. In some embodiments, the meter readings may be from a preceding interval. For instance, if the interval for which the DR event is assessed is from 2:00 PM to 2:05 PM, then the meter reading may be from the interval of 1:55 PM to 2:00 PM. In some alternative embodiments, the real-time demand may be estimated using one or more demand forecasting algorithms, read from the third party server 134. In these and other embodiments, the economic data and the estimated real-time demand may be used to determine a demand imbalance for the time period associated with the DR event.

The DR module 204 may determine a target resource curtailment that maximizes profitability of the DR event. The DR module 204 may determine the target resource curtailment by minimizing a cost of the DR event and taking into consideration changes to the economic data as curtailment occurs. For example, in some embodiments, the DR module 204 may forecast a real-time price as a function of a curtailment request amount included in the DR event. As residences curtail the resource, the demand may correspondingly decrease, which may affect the real-time price. The DR module 204 may take the changes to the demand and to the price into consideration responsive to determining the target resource curtailment.

The DR module 204 may determine a target cost of the DR event. The target cost may include an estimated price of a resource for the DR event multiplied by a quantity of the resource. For example, a resource for the DR event may include energy. The DR module 204 may determine that the target price is $20.00 per MW per hour and the quantity of energy is 100 MW per hour. As a result, the target cost may be $2000.00.

The target cost of the DR event may also be a function of the target resource curtailment. For example, if the DR event includes a larger target resource curtailment, then the cost of the DR event may be higher than a cost of a DR event that involves a lower target resource curtailment. The determination of the target resource curtailment may be based at least partially on the cost of the DR event. For instance, if the cost of the DR event is greater than a potential profitability, then the DR module 204 may determine that the target resource curtailment amount may be zero and, as a result, the DR module 204 may not determine a DR event.

The determination of the target resource curtailment and the target cost may be based on historical data. Additionally or alternatively, the determination may be based on the location or zone of the residences and/or the users. For example, if the real-time LMP of the resource for a distribution channel increases, then the DR module 204 may identify residences located on the distribution channel to curtail the resource during the DR event. Alternatively, if the real-time LMP of the resource for another distribution channel increases, then the DR module 204 may identify residences located on the other distribution channel to curtail the resource during the DR event. The DR module 204 may accordingly balance demand across multiple distribution channels to maximize profitability of a DR event.

The DR module 204 may identify a user to be matched with coupons based on a likelihood that the user may redeem a coupon at a store during a time period associated with a DR event. When the user is at the store instead of the user's residence, the residence may consume less of a resource. The DR module 204 may determine the likelihood that the user may redeem the coupon based on an interest specified by the user to participate in a DR event and a historical performance. The historical performance may include when users redeemed coupons, such as whether a user consistently redeems coupons between 1 p.m. and 4 p.m., but not before 1 p.m. The DR module 204 may use the historical performance to select users for a DR event that occurs at a certain time of the day. The historical performance may also include a percentage of coupons that were redeemed, and analytical data, such as whether the coupon includes an offer over a threshold amount before a user redeems the coupon. The DR module 204 may rank users or categorize users according to levels of likelihood of redeeming a coupon. The DR module 204 may identify a set of users to offer coupons to.

The DR module 204 may transmit information about the users and the user interests to the coupon module 206, which may determine a match between offers and users. The DR module 204 may receive a reply from one or more of the users that received a coupon agreeing to redeem the coupon. Based on the reply and/or the likelihood that each of the users redeems a coupon, the DR module 204 may determine a subset of users to receive coupons. The DR module 204 may estimate a load reduction for each user in the subset by determining types of home appliances associated with the user. The DR module 204 may also use a historical performance to estimate the load reduction. For example, the DR module 204 may use a previous curtailment of a resource at a residence associated with a user that participated in a previous DR event to estimate the load reduction for the user.

The DR module 204 may classify resident appliances according to different types of DR products and resources. The DR module 204 may classify a resource according to a type of resource and a type of targeted service. The DR module 204 may classify the resource based on a timeline and a reliability of the resource, a commitment level, and a cost and bidding strategy. After the DR module 204 classifies the resource, the DR module 204 may decide which product to apply the resource to.

Table 1 includes different types of DR products and resources as organized according to MISO. Energy refers to reduction in short term energy use in a real-time market or a day-ahead market, which results in lower short term prices for users. Regulation reserve refers to an ability to decrease or increase demand or supply within seconds with a full range capability within 20 minutes. Spin/supplemental reserve refers to an ability to decrease demand or increase supply within 10 minutes and hold for a specified period. Module E may be a resource adequacy construct that tracks utility-based forecasts. Emergency energy refers to reducing a demand responsive to demand threatening to exceed supply. Emergency energy may be used to avoid rolling blackouts.

DRR Type I may be a resource hosted by an energy consumer, load serving entity, or an aggregator of retail customers (ARC) within a MISO balancing authority area that (i) may be registered to participate in an energy and operating reserve market, (ii) may be capable of supplying a specific quantity of energy, contingency server, or capacity, at a choice of a market participant, to an energy and operating reserve market through physical load interruption, (iii) may be capable of complying with a transmission provider's instructions, and (iv) may have appropriate metering equipment installed.

DRR Type II may be a resource hosted by an energy consumer, load serving entity, or an ARC within a MISO balancing authority area that (i) may be registered to participate in an energy and operating reserve market, (ii) may be capable of supplying a range of energy and/or operating reserve, at a choice of a market participant, to an energy and operating reserve market through behind a meter generation and/or controllable load, (iii) may be capable of complying with a transmission provider's setpoint instructions, and (iv) may have appropriate metering equipment installed.

Load modifying resources (LMR) may include LMR DR and LMR behind the meter generation resource (BTMG). LMR DR may manage interruptible loads or direct control loads and other resources that may reduce demand during emergencies. LMR BTMG may generate resources used to serve wholesale or retail load located behind a commercial pricing node (CPNode) that may not be included in a transmission provider's setpoint instructions.

Emergency demand response (EDR) resources may reduce a cost to market participants during emergency conditions and may be compensated for their services based on their offers and a LMP.

TABLE 1

| Resource | Product | | | | |
|---|---|---|---|---|---|
| DRR - Type I | Energy | Regulation | Spin/ | Module E | Emergency |
| | | Reserve | Supple- | (PRC) | Energy |
| | | | mental | | |
| | | | Reserve | | |
| DRR - Type II | X | | X | X | X |
| LMR DR | X | X | X | X | X |
| LMR BTMG | | | | X | X |
| EDR | | | | | X |

The DR module 204 may determine a profit (such as a maximized profit) and/or a risk (such as a minimized risk) and use the profit and/or the risk to bid for a resource. The DR module 204 may specify a profit margin or a buffer for risk management that is used as a factor in maximizing the profit or minimizing the risk.

The DR module 204 may determine parameters of a supply curve to maximize a profit. For example, the DR module 204 may determine an offer price (P) and a quantity (D) (e.g., a demand) where the supply curve is used to determine an offer price as a function of a demand bid (Dᵢ, Pᵢ) in the supply curve to maximize the profit. The supply curve may include a single stage supply curve with a single pair of parameters (D₁, P₁), a multiple stage supply curve with multiple pairs of parameters (Dᵢ, Pᵢ), or a linear supply curve with linear parameters (Dₘᵢₙ, Dₘₐₓ, Pₘᵢₙ, Pₘₐₓ). In some embodiments, Dₘᵢₙ is specified by a third-party server 134 as a constant constraint for the minimum demand eligible to participate in the bidding process.

The DR module 204 may determine the following parameters: a price of a demand response (P_{DR}), a type of DR product to bid, a bidding supply curve including a price and a quantity, a forecasted price on a day-ahead market a day ahead for each hour of a next day (P_{DA}), and a forecasted price on a real-time market for each hour of a next day (P_{RT}).

The DR module 204 may assume that curtailing the resource during the DR event represents a small enough contribution to an overall supply from an LSE or a DR aggregator that the curtailing does not affect an LMP enough to remodel the aggregated supply curve from numerous market participants.

The supply curve may assume that a forecasted price for a day-ahead market (P_{DA}) is equivalent to the LMP responsive to a quantity of the resource being the same as a demand for the resource. As a result, the DR module 204 may model a supply bid based on a clearing demand (D_{c}) contributed from the LSE or the DR aggregator.

The DR module 204 may generate a linear supply bid from a supply curve based on a linear function. Case 1 states: if p_{da}<pₘᵢₙ [symbol] D_{c}=0. Case 2 states: if

$${p}_{min} \leq {p}_{da} \leq {p}_{max} ⇒ {D}_{c} = \frac{{p}_{da} - {p}_{min}}{{p}_{max} - {p}_{min}} * ( {D}_{max} - {D}_{min} ) + {D}_{min} .$$

Case 3 states: if p_{da}>pₘₐₓ [symbol] D_{c}=Dₘₐₓ.

The DR module 204 may model a price forecast of both a day-ahead price (P_{DA}) and a real-time price (P_{RT}) as probabilistic functions, each with a cumulative distribution function (CDF) (F_{P}_{_{DA}}(p_{da})) and (F_{P}_{_{RT}}(pᵣₜ)), respectively. The DR module 204 may use the price forecast to generate the CDF of a price. The DR module 204 may determine a price range that includes a lower bound (pₗ) and an upper bound (pᵤ). A function or value of the lower bound (Fₚ(pₗ)) may be zero and a function or value of the upper bound (Fₚ(pᵤ)) may be 1. For example, the upper bound may be a price cap specified by a market operator (e.g., ISO).

The DR module 204 may apply price scenarios to the probabilistic function where (p) represents a price (e.g., a maximum price may be represented as pₘₐₓ), (D) represents a demand (e.g., a maximum demand may be represented as Dₘₐₓ), (F) represents a cumulative distribution function (e.g., a cumulative distribution function of a maximum price may be represented as F_{P}(pₘₐₓ)), and a probability distribution function may be represented as (prob). For example, case 1 states: if pₘₐₓ<pₗ [symbol] F_{P}(pₘₐₓ)=0≡prob(D_{C}=Dₘₐₓ)=1. Case 2 states: if pₘᵢₙ≦pₗ≦pₘₐₓ [symbol] F_{P}(pₘᵢₙ)=0; (2-1) if

$${p}_{min} \leq {p}_{da} \leq {p}_{max} ⇒ prob ( {D}_{c} = ( \frac{{P}_{DA} - {P}_{min}}{{P}_{max} - {P}_{min}} ) \cdot ( {D}_{max} - {D}_{min} ) + {D}_{min} ) = {F}_{P} ( {p}_{max} ) ;$$

(2-2) if pₘₐₓ<p_{da} [symbol] prob(D_{C}=Dₘₐₓ)=1−F_{P}(pₘₐₓ). Case 3 states: if pₗ<pₘᵢₙ≦pₘₐₓ<pᵤ [symbol] 0<F_{P}(pₘᵢₙ)≦F_{P}(pₘₐₓ)<1; (3-1): if p_{da}<pₘᵢₙ [symbol] prob(D_{C}=0)=F_{P}(pₘᵢₙ); (3-2): if

$${p}_{min} \leq {p}_{da} \leq {p}_{max} ⇒ prob ( {D}_{c} = ( \frac{{P}_{DA} - {P}_{min}}{{P}_{max} - {P}_{min}} ) \cdot ( {D}_{max} - {D}_{min} ) + {D}_{min} ) = {F}_{P} ( {p}_{max} ) - {F}_{P} ( {p}_{min} ) ;$$

(3-3): if pₘₐₓ<p_{da} [symbol] prob(D_{C}=Dₘₐₓ)=1−F_{P}(pₘₐₓ).

The DR module 204 may estimate an aggregated curtailment of a resource for the subset of users that receive coupons. The DR module 204 may determine that for user (i) with an individual curtailment (dᵢ), the individual curtailment may be a multiplication of two random variables: a likelihood (i.e., a demand flexibility estimation) that the user will participate in the DR event by redeeming the coupon (lᵢ) and a distribution of load reduction if the user redeems the coupon (cᵢ). The relationship may be expressed as: dᵢ=lᵢ·cᵢ.

The DR module 204 may estimate an aggregated curtailment ( [symbol] ) for the subset of users that receive coupons (R) from all users (i) based on users that redeem the coupon (lᵢ) and the distribution of load reduction if the user redeems the coupon (cᵢ) as: [symbol] =Σ_{iεR}lᵢ. cᵢ, where . A simplified model may assume that a likelihood of participation is a discrete random variable and a load reduction is modeled as a normal distribution. As a result, the DR module 204 may estimate the aggregated curtailment as a normal distribution (N): [symbol] =N(Σ_{iεR}lᵢ·E[cᵢ], Σ_{iεR}lᵢ²·σ²[cᵢ]) where lᵢ represents the likelihood that users participate in the DR event, cᵢ represents the distribution of load reduction if the user redeems the coupon, E [cᵢ] represents the expected value (i.e., a mean) of distribution cᵢ, and σ² represents a variance of distribution cᵢ.

The DR module 204 may use the aggregated curtailment, a day-ahead forecast, and a real-time price to determine a maximized profit. The profit may be defined as: P_{DA}·D_{C}−P_{DR}·D_{R}−P_{RT}·(D_{C}−D_{R})=D_{C}·(P_{DA}−P_{RT})+D_{R}·(P_{RT}−P_{DR}). P_{DA}·D_{C} may be described as a resource credit that includes a price of purchasing the resource from a day-ahead market (P_{DA}) multiplied by a clearing demand for a submitted DR bidding (D_{C}). A price for a demand response incentive (P_{DR}·D_{R}) may be subtracted from the resource credit. P_{RT}·(D_{C}−D_{R}) may be described as a price of purchasing the resource from a real-time market (P_{RT}) multiplied by a difference between the clearing demand for the submitted DR bidding and actual performance after the DR event (D_{R}).

The DR module 204 may determine the maximized profit based on whether a bid is for too much or too little of a resource. If the aggregated curtailment (D_{R}) is less than a clearing demand contributed from the LSE (D_{C}), the LSE may need to buy energy from the real-time market at an extra cost of P_{RT}·(D_{C}−D_{R}). For example, if the DR module 204 bids on the day-ahead LMP and supplies 100 MW of curtailment energy for $20.00 per MW, the DR module 204 is paid $2000.00. If the actual demand curtailment is 95 MW and the real-time LMP is $23, the DR module 204 purchases 5 MW at $23 per MW for an extra charge of $115.00.

If the aggregated curtailment (D_{R}) is greater than the clearing demand contributed from the LSE (D_{C}), the LSE receives an extra credit from the real-time market of P_{RT}·(D_{R}−D_{C}). For example, if the DR module 204 bids on the day-ahead LMP and supplies 100 MW of curtailment energy for $25.00 per MW, the DR module 204 is paid $2500.00. If the actual demand curtailment is 105 MW and the real-time LMP is $20, the DR module 204 receives a credit of 5 MW at $20 per MW or a total of $100.00.

The DR module 204 may determine a maximized profit (max₍ₚ_{ₘᵢₙ}_{,p}_{ₘₐₓ}_{,d}_{ₘₐₓ}₎) based on a minimum price (pₘᵢₙ), a maximum price (pₘₐₓ), and a maximum demand (dₘₐₓ) by estimating a day-ahead price CDF, a real-time price CDF, and an aggregated curtailment CDF. For example, the following example may be based on a linear supply curve:

max₍ₚ_{ₘᵢₙ}_{,p}_{ₘₐₓ}_{,d}_{ₘₐₓ}₎E[D_{C}·(P_{DA}−P_{RT})+D_{R}·(P_{RT}−P_{DR})]=max₍ₚ_{ₘᵢₙ}_{,p}_{ₘₐₓ}_{,d}_{ₘₐₓ}₎Σ₍ₚ_{_{da}}_{,p}_{ᵣₜ}_{,d}_{ᵣ}₎prob(p_{da},pᵣₜ,dᵣ)·[D_{C}·(p_{da}−pᵣₜ)+dᵣ·(pᵣₜ−P_{DR})].

The DR module 204 may quantify variable spaces (p_{da},pᵣₜ,dᵣ) with a quantification step (Δ_{da},Δᵣₜ,Δᵣ). Next: f_{P}_{_{DA}}(p_{da})=F_{P}_{_{DA}}(p_{da}+½Δ_{da})−F_{P}_{_{DA}}(p_{da}−½Δ_{da}). f_{P}_{_{DA}}(p_{da}) represents the probability of day-ahead price equal to p_{da}. The value of f_{P}_{_{DA}}(p_{da}) is estimated based on the quantified value of the cumulative distribution function F_{P}_{_{DA}} around p_{da}, i.e., difference of F_{P}_{_{DA}}(p_{da}+½Δ_{da}) and F_{P}_{_{DA}}(p_{da}−½Δ_{da}). A probability of the variable spaces (prob(p_{da},pᵣₜ,dᵣ)) for a day-ahead price (p_{da}), a real-time price (p_{da}), and a real-time demand (dᵣ) may be calculated by simplifying the variable spaces as independent random variables that may be expressed as: prob(p_{da},pᵣₜ,dᵣ)=f_{P}_{_{DA}}(p_{da})·f_{P}_{_{RT}}(pᵣₜ)·f_{D}_{_{R}}(dᵣ).

The DR module 204 may determine the maximized profit by specifying a quantification step (Δ_{da},Δᵣₜ,Δᵣ) and performing an exhaustive search of the output variable spaces (p_{da},pᵣₜ,dᵣ) to find an optimal objective value. This may be expressed as profit(pₘᵢₙ,pₘₐₓdₘₐₓ)=Σ₍ₚ_{_{da}}_{,p}_{ᵣₜ}_{,d}_{ᵣ}₎prob(p_{da},pᵣₜ,dᵣ)·[D_{C}·(p_{da}−pᵣₜ)+dᵣ·(pᵣₜ−p_{DR})] where the clearing demand (D_{C}) may be calculated based on the model for the linear supply bid described above. In some embodiments, the search may start from a large value of quantification step (Δ_{da},Δᵣₜ,Δᵣ). The value of the maximized profit may be recorded. The process of determining the maximized profit may continue by reducing the value of quantification step (Δ_{da},Δᵣₜ,Δᵣ). The search may stop when the maximized profit value may not be further improved.

The DR module 204 may use the maximized profit to bid for a price and quantity of a resource on a day-ahead market. If the DR module 204 fails to win a bid, the DR module 204 may bid for a price and quantity of the resource on a real-time market. If the DR module 204 wins the bid, the DR module 204 may notify the subset of users of a confirmed DR event. The DR module 204 may remind the subset of users of the confirmed DR event a certain amount of time before the DR event occurs.

During the bidding, the DR module 204 may specify a location of a resource that may be curtailed during the DR event. For example, the DR module 204 may specify addresses of residences associated with the subset of users that receive coupons that are participating in the DR event. The DR module 204 may advantageously determine that the subset of users are participating in the DR event based on determining a likelihood that the users will redeem the coupons. In addition, the DR module 204 may receive indications from one or more of the users that the users agree to redeem the coupons during the DR event.

The coupon module 206 may be configured to identify a match between an offer and a user and generate a coupon for the user that includes the offer and other incentives, such as a performance bonus and an emergency bonus.

The coupon module 206 may receive an identification of users from the DR module 204 to match with offers. For example, the DR module 204 may send an initial subset of users that include a high likelihood of redeeming a coupon. The coupon module 206 may also receive user interests associated with the users.

The coupon module 206 may receive offers from the merchant servers 115 of FIG. 1. For example, the coupon module 206 may send a request to the merchant servers 115 for offers. Alternatively or additionally, the merchant servers 115 may send offers to the coupon module 206 periodically, (e.g., every five minutes, every hour, every day, etc.), randomly, pseudo-randomly, or on-demand. The coupon module 206 may provide the merchants with a deadline for sending the offers.

The offers may include a purchase incentive to purchase a good or service and a category of interest associated with the good or service. For example, an offer may include a 10% discount off of food or drink at a cafe that serves tea.

The coupon module 206 may identify a match between an offer from the multiple offers and the user. The coupon module 206 may identify the match based on identifying categories of interest associated with a good or service that is part of the offer and user interests associated with a user. For example, the coupon module 206 may determine that the offer for the 10% discount at the cafe includes the category of tea and the coupon module 206 may match the offer with a user with a user interest in tea. In some embodiments, the coupon module 206 may match an offer with a user based on a user's preference for a type of coupon. The type may include a preference for a type of reward, such as a percentage discount, a monetary discount, or reward points.

The coupon module 206 may notify merchants of matching offers. For example, the coupon module 206 may notify merchants at certain times during a day. Alternatively, merchants may specify how long in advance (e.g., three days) to receive a notification about a matching offer.

The coupon module 206 may generate a coupon for the user that includes the offer. For example, the coupon may include a 10% discount for redeeming the coupon. The coupon module 206 may also receive a time period associated with a demand response event. The coupon module 206 may generate a coupon with a performance bonus that provides a performance incentive to redeem the coupon at a specified physical location during the time period associated with the demand response event. For example, the coupon may include the 10% discount for redeeming the coupon and an extra 5% discount for redeeming the coupon at the cafe during 3:00-3:30 pm. In some embodiments, a performance incentive may be associated with a specific date of a demand response event. In addition, a performance incentive may depend on the actual resource curtailment associated with a demand response event. The calculation of the actual resource curtailment may be provided by the measurement and verification module 210.

In some embodiments, the coupon module 206 may pay for a performance incentive on behalf of a utility by reimbursing the merchant for the performance incentive. The coupon module 206 may reimburse the merchant at a different rate than a face value for the performance incentive. For example, the coupon module 206 may reimburse the merchant for 30% of a value of the performance incentive.

In some embodiments, the coupon module 206 may generate a coupon that includes a sign-up bonus that provides a sign-up incentive to a user that agrees to redeem the coupon during the time period associated with the DR event. For example, the coupon module 206 may provide an additional discount to the user, provide reward points for a loyalty program that may be redeemed at participating locations, etc. The sign-up bonus may include a deadline for responding to agree to redeem the coupon. The deadline may be advantageous for the DR module 204 to use in bidding on a day-ahead market or an hour-ahead market. An action may qualify as an agreement without being an explicit agreement from the user. For example, the agreement may include a request from the user to reserve a table at a restaurant during the time period associated with the DR event. The sign-up bonus may be used in conjunction with a performance bonus for a DR event that occurs during a peak time, such as energy consumption during a hottest time of a day.

A merchant, a utility, or a combination of the merchant and the utility may pay for the sign-up incentive. The coupon module 206 may track whether the user adhered to the agreement to redeem the coupon during the time period associated with the DR event. For example, if the coupon is not redeemed during the time period associated with the DR event or not redeemed at all, the coupon module 206 may revoke a sign-up incentive conferred at a time that the user agreed to redeem the coupon.

In some embodiments, the coupon module 206 may generate a coupon that includes an emergency bonus that provides an emergency incentive to redeem within a shortened time period. For example, the shortened time period may be a few minutes from when a user receives the coupon. The emergency incentive may be used to compensate for a shortfall of supply.

In some embodiments, the coupon module 206 determines a user location associated with a user and filters offers from merchants to determine a subset of merchants with store locations that are within a threshold range of distances from the user location. The user location may include, for example, a residence associated with the user. The coupon module 206 may use an offer from one of the subset of merchants so that the store location may be close enough for the user to reach it during the shortened time period. The emergency bonus may be advantageously used in a neighborhood when a resource, such as an electricity supply, may be tight and a utility would like to encourage users that live in the neighborhood to reduce energy consumption at their residences.

The coupon module 206 may notify merchant servers 115 with information about the coupons. For example, the coupon module 206 may notify a merchant server 115 if the coupon module 206 uses an offer from the merchant server 115 to send a coupon to a user. The coupon module 206 may include a time period associated with a DR event when the user may redeem the coupon. In another example, the coupon module 206 may notify a merchant server 115 if the user agrees to redeem the coupon during a time period associated with a DR event. The merchant server 115 may advantageously use the information to prepare for the user. For example, where the user agrees to redeem the coupon during a time period associated with a DR event by making a reservation at a restaurant, the restaurant may use the reservation to determine how much food to prepare in advance for the restaurant. In yet another example, the merchant server 115 may request that the coupon module 206 notify the merchant server 115 if the coupon module 206 provides an incentive offer with a value above a threshold value. For example, the coupon module 206 may notify the merchant server 115 if the incentive offer is for more than $5 worth of goods or services. Upon reception of such a notification, the merchant server 115 may generates a coupon with an additional incentive offer from the merchant server 115.

The coupon module 206 may receive a notification from the merchant server 115 if a user redeems a coupon at a store. If the coupon included an incentive to provide the user with reward points, the coupon module 206 may add the reward points to the user's account responsive to receiving the notification from the merchant server 115.

The user interface module 208 may generate graphical data for displaying a user interface. The user interface module 208 may receive instructions from the registration module 202 to generate a user interface for a user to enter information for registering the user for display on a user device 120. The user interface module 208 may receive instructions from the coupon module 206 to generate graphical data for displaying a coupon on a user device 120.

The measurement and verification module 210 may be configured to receive information about a resource and verify that users redeemed coupons. For example, the measurement and verification module 210 may receive a meter data report. The measurement and verification module 210 may use the information about the resource to determine whether residences experienced a curtailment of the resource. The measurement and verification module 210 may transmit a determination about the curtailment of the resource to the DR module 204, which may update historical response information associated with users based on the determination about the curtailment of the resource.

The measurement and verification module 210 may use the determination about the curtailment of the resource to verify that users adhered to a DR program. For example, if a user redeemed the coupon but kept appliances running at the user's residence while the user redeemed the coupon, the verification module 210 may determine that the user failed to satisfy terms of the DR program. As a result, the verification module 210 may cancel bonuses associated with the coupon. For example, if the coupon module 206 received an indication that the user agreed to redeem the coupon and received 100 reward points for making the agreement, the verification module 210 may deduct the 100 reward points from the user's account.

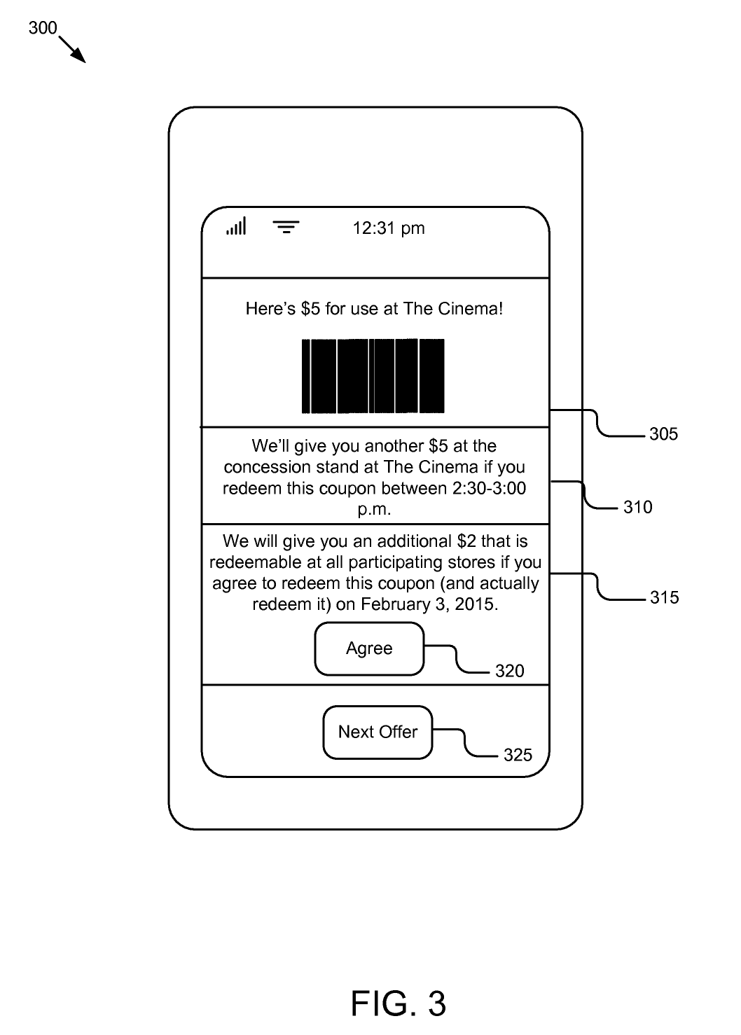

FIG. 3 illustrates an example graphical user interface 300 that includes a coupon and different types of incentives. In this example, the coupon includes a portion 305 with an offer and a barcode to redeem the coupon for $5 off at the Cinema. The coupon also includes a performance incentive 310 to redeem the coupon at the concession stand between 2:30-3:00 p.m. during any weekdays in February 2015. to receive another $5 off (e.g., toward a concession stand purchase). The coupon includes a sign-up incentive 315 to receive an additional $2 value that is redeemable at a participating store if the user selects an agree button 320 to agree to redeem the coupon at a particular date (e.g., in this example, Feb. 3, 2015). The coupon module 206 may generate multiple coupons for the user that the user may view by selecting a next offer button 325.

FIG. 4 illustrates a flowchart of an example method 400 to match a coupon with a user to be redeemed during a DR event, arranged in accordance with at least some embodiments described herein. The method 400 may be implemented, in whole or in part, by one or more of the DR server 101 of FIG. 1, the DR application 111 of FIG. 1 or 2, the device 200 of FIG. 2, or another suitable device, server, and/or system. The method 400 may begin at block 402.

At block 402, one or more user interests associated with a user are determined. For example, the DR application 111 and/or the registration module 202 determine user interests. A user may explicitly provider user interests or the DR application 111 and/or the registration module 202 may link to another account, such as a social network that includes user interests.

At block 404, multiple offers may be received from multiple merchants that each include a purchase incentive to purchase a good or service and a category of interest associated with the good or service. For example, the DR application 111 and/or the coupon module 206 may receive multiple offers from multiple merchants that each include the purchase incentive to purchase the good or service and the category of interest associated with the good or service. In some embodiments, the good or service may be associated with multiple categories of interest.

At block 406, a match may be identified between an offer from the multiple offers and the user, including matching the one or more user interests associated with the user to the category of interest associated with the good or service. For example, the DR application 111 and/or the coupon module 206 identifies the match between the offer from the multiple offers and the user, including matching the one or more user interests associated with the user to the category of interest associated with the good or service. The user interest and the category of interest may be identical, or the user interest may include a species of the category of interest (or vice versa), or the user interest may be similar to the category of interest, or the like. Matches may be based on a target group of users, e.g. retirees or homemakers. Matches may be based on the locations of the users at the time of a demand response event. For example, if coupon module 206 identifies that a user stays at his/her residency during the hours of previous demand response events, the user may be considered a high priority user to match to coupons with a higher value. In yet another example, matches may be based on the historical shopping records.

At block 408, a time period associated with a DR event may be determined. For example, the DR application 111 and/or the DR module 204 may determine the time period associated with the DR event.

At block 410, a coupon may be generated for the user that includes the offer and a performance bonus that provides a performance incentive to redeem the coupon at a specified physical location during the time period associated with the DR event. For example, the DR application 111 and/or the coupon module 206 may generate the coupon for the user that includes the offer and a performance bonus that provides a performance incentive to redeem the coupon at a specified physical location during the time period associated with the DR event.

At block 412, the coupon may be provided to the user for redemption at the specified physical location, the redemption of the coupon at the specified physical location by the user causing a reduction in resource consumption at a residential location associated with the user. For example, the DR application 111 and/or the coupon module 206 may provide the coupon to the user for redemption at the specified physical location.

FIG. 5 illustrates a flowchart of an example method 500 to bid for a resource based on a DR event. The method 500 may be implemented, in whole or in part, by one or more of the DR server 101 of FIG. 1, the DR application 111 of FIG. 1 or 2, the device 200 of FIG. 2, or another suitable device, server, and/or system. The method 500 may begin at block 502.

At block 502, a target cost and a target resource curtailment associated with a DR event may be determined. For example, the DR application 111 of FIG. 1 and/or the DR module 204 may determine a target cost and a target resource curtailment associated with a DR event.

At block 504, multiple offers may be received from merchants. For example, the DR application 111 of FIG. 1 and/or the coupon module 206 may receive multiple offers from merchants.

At block 506, a likelihood that each of multiple users will redeem a coupon at a specified physical location during a time period associated with the DR event may be determined. For example, the DR application 111 of FIG. 1 and/or the DR module 204 may determine the likelihood that each of multiple users will redeem a coupon at the specified physical location during the time period associated with the DR event.

At block 508, a set of coupons may be generated and provided to a subset of the multiple users based on the target cost, the target resource curtailment, and the likelihood that each of the multiple users will redeem the coupon. For example, the DR application 111 of FIG. 1 and/or the coupon module 206 may generate and provide the set of coupons to the subset of the multiple users based on the target cost, the target resource curtailment, and the likelihood that each of the multiple users will redeem the coupon.

At block 510, an aggregated curtailment of a resource based on the subset of multiple users receiving the coupons may be estimated. For example, the DR application 111 of FIG. 1 and/or the DR module 204 may estimate the aggregated curtailment of the resource based on the subset of multiple users receiving the coupons.

At block 512, parameters of a supply curve to maximize profit based on the aggregated curtailment of the resource may be determined. For example, the DR application 111 of FIG. 1 and/or the DR module 204 may determine the parameters of the supply curve to maximize the profit based on the aggregated curtailment of the resource.

At block 514, a resource on a day-ahead market may be bid for by providing an offer price and a quantity for the resource based on the parameters of the supply curve. For example, the DR application 111 of FIG. 1 and/or the DR module 204 may bid for the resource on the day-ahead market by providing the offer price and the quantity for the resource based on the parameters of the supply curve.

The embodiments described herein may include the use of a special-purpose or general-purpose computer including various computer hardware or software modules, as discussed in greater detail below.

Embodiments described herein may be implemented using computer-readable media for carrying or having computer-executable instructions or data structures stored thereon. Such computer-readable media may include any available media that may be accessed by a general-purpose or special-purpose computer. By way of example, and not limitation, such computer-readable media may include non-transitory computer-readable storage media including random access memory (RAM), read-only memory (ROM), electrically erasable programmable read-only memory (EEPROM), compact disc read-only memory (CD-ROM) or other optical disk storage, magnetic disk storage or other magnetic storage devices, flash memory devices (e.g., solid state memory devices), or any other storage medium which may be used to carry or store desired program code in the form of computer-executable instructions or data structures and which may be accessed by a general-purpose or special-purpose computer. Combinations of the above may also be included within the scope of computer-readable media.

Computer-executable instructions may include, for example, instructions and data which cause a general-purpose computer, special-purpose computer, or special-purpose processor device (e.g., one or more processors) to perform a certain function or group of functions. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

As used herein, the terms “module” or “component” may refer to specific hardware embodiments configured to perform the operations of the module or component and/or software objects or software routines that may be stored on and/or executed by general-purpose hardware (e.g., computer-readable media, processor devices, etc.) of the computing system. In some embodiments, the different components, modules, engines, and services described herein may be implemented as objects or processes that execute on the computing system (e.g., as separate threads). While some of the system and methods described herein are generally described as being implemented in software (stored on and/or executed by general-purpose hardware), specific hardware embodiments or a combination of software and specific hardware embodiments are also possible and contemplated. In this description, a “computing entity” may be any computing system as previously defined herein, or any module or combination of modulates running on a computing system.

All examples and conditional language recited herein are intended for pedagogical objects to aid the reader in understanding the invention and the concepts contributed by the inventor to furthering the art, and are to be construed as being without limitation to such specifically recited examples and constraints. Although embodiments of the present inventions have been described in detail, it should be understood that the various changes, substitutions, and alterations could be made hereto without departing from the spirit and scope of the invention.

1. A method to manage resource usage for a demand response event, the method comprising:
determining one or more user interests associated with a user;
receiving multiple offers from multiple merchants that each include a purchase incentive to purchase a good or service and a category of interest associated with the good or service;
identifying a match between the user and an offer from the multiple offers, including matching the one or more user interests associated with the user to the category of interest associated with the good or service;
determining a time period associated with a demand response event during which an aggregate resource consumption is to be reduced;
generating a coupon for the user that includes the offer and a performance bonus that provides a performance incentive to redeem the coupon at a specified physical location during the time period associated with the demand response event; and
providing the coupon to the user for redemption at the specified physical location, redemption of the coupon at the specified physical location by the user causes a reduction in resource consumption at a residential location associated with the user.

2. The method of claim 1, wherein the coupon further includes a sign-up bonus that provides a sign-up incentive to agree to redeem the coupon during the time period associated with the demand response event.

3. The method of claim 2, further comprising:
receiving an indication from the user that the user agrees to redeem the coupon during the time period associated with the demand response event; and
notifying a merchant associated with the offer that the user agreed to redeem the coupon during the time period associated with the demand response event.

4. The method of claim 1, further comprising receiving the one or more user interests from the user to determine the one or more user interests associated with the user.

5. The method of claim 1, further comprising:
determining a user location associated with the user;
determining store locations associated with the multiple merchants; and
identifying a subset of merchants with store locations that are within a threshold range of distances from the user location.

6. The method of claim 5, further comprising:
filtering the multiple offers from the multiple merchants to narrow the multiple offers to filtered offers from the subset of merchants with store locations that are within the threshold range of distances from the user location;
wherein identifying the match between the offer from the multiple offers and the user comprises identifying the match between the offer from the filtered offers and the user; and
wherein the coupon further includes an emergency bonus that provides an emergency incentive to redeem within a shortened time period.

7. The method of claim 1, further comprising receiving information from the user about one or more of an address associated with the user, shopping preferences, and an interest in a type of coupon.

8. A non-transitory computer-readable medium that includes computer-readable instructions stored thereon that are executable by a processor to perform or control performance of operations comprising:
determining one or more user interests associated with a user;
receiving multiple offers from multiple merchants that each include a purchase incentive to purchase a good or service and a category of interest associated with the good or service;
identifying a match between the user and an offer from the multiple offers, including matching the one or more user interests associated with the user to the category of interest associated with the good or service;
determining a time period associated with a demand response event during which an aggregate resource consumption is to be reduced;
generating a coupon for the user that includes the offer and a performance bonus that provides a performance incentive to redeem the coupon at a specified physical location during the time period associated with the demand response event; and
providing the coupon to the user for redemption at the specified physical location, redemption of the coupon at the specified physical location by the user causes a reduction in resource consumption at a residential location associated with the user.

9. The non-transitory computer-readable medium of claim 8, wherein the coupon further includes a sign-up bonus that provides a sign-up incentive to agree to redeem the coupon during the time period associated with the demand response event.

10. A method to bid for a resource based on a demand response event, the method comprising:
determining a target cost and a target resource curtailment associated with a demand response event;
receiving multiple offers from merchants;
determining a likelihood that each of multiple users will redeem a coupon that includes one or more of the multiple offers from merchants at a specified physical location during a time period associated with the demand response event;
generating and providing a set of coupons to a subset of the multiple users based on the target cost, the target resource curtailment, and the likelihood that each of the multiple users will redeem the coupon, redemption of one or more coupons in the set of coupons at the specified physical location by one or more of the multiple users causing a reduction in resource consumption at one or more residential locations associated with the one or more of the multiple users;
estimating an aggregated curtailment of the resource based on the subset of the multiple users that receive the coupons; and
bidding for the resource on a day-ahead market by providing an offer price and a quantity for the resource based on the aggregated curtailment.

11. The method of claim 10, further comprising:
determining parameters of a supply curve to maximize a profit based on the aggregated curtailment of the resource; and
wherein the offer price and the quantity for the resource are based on the profit.

12. The method of claim 11, wherein determining the profit comprises:
determining a resource credit that includes a price of purchasing the resource from the day-ahead market multiplied by a clearing demand for a submitted DR bidding; and
subtracting from the resource credit a price for a demand response incentive.

13. The method of claim 12, wherein determining the profit is based on generating a supply curve to determine the offer price and the quantity for the resource.

14. The method of claim 12, wherein determining the profit comprises modeling a day-ahead price forecast on the day-ahead market and a real-time price forecast on a real-time market as probabilistic functions, each with a cumulative distribution function.

15. The method of claim 10, wherein each coupon includes an offer and a performance bonus that provides a performance incentive to redeem the coupon at the specified physical location during the time period associated with the demand response event.

16. The method of claim 10, further comprising:
updating the target cost and the target resource based on new information;
generating and providing an additional set of coupons to an additional subset of the multiple users based on the updated target cost, the updated target resource curtailment, and the likelihood that each of the multiple users will redeem the coupon; and
bidding for the resource on an hour-ahead market by providing the updated target cost and the updated target resource curtailment.

17. The method of claim 10, wherein determining the likelihood that each of the multiple users will redeem the coupon at the specified physical location during the time period associated with the demand response event is based on an interest specified by each of the users.

18. The method of claim 10, wherein estimating the aggregated curtailment of the resource based on the subset of the multiple users receiving the coupons includes determining a sum of the likelihood that each of the users in the subset of multiple users will redeem the coupon multiplied by a load reduction for each of the users in the subset of multiple users.

19. The method of claim 18, wherein determining the load reduction is based on determining types of appliances at each residential location of the users and resource consumption associated with the types of appliances at each residential location of the multiple users receiving the coupons.

20. The method of claim 18, wherein the likelihood that each of the users in the subset of multiple users will redeem the coupon and the load reduction for each of the users in the subset of multiple users are independent variables.
